(19) United States
(12) Patent Application Publication
(10) Pub. No.: US 2017/0292170 A1
(43) Pub. Date: Oct. 12, 2017

(54) CONTROLLING AND OPTIMISING FURNACE ATMOSPHERES FOR STAINLESS STEEL HEAT TREATMENT

(71) Applicant: Akin Malas, New Providence, NJ (US)

(72) Inventor: Akin Malas, New Providence, NJ (US)

(21) Appl. No.: 15/472,317

(22) Filed: Mar. 29, 2017

Related U.S. Application Data
(60) Provisional application No. 62/318,932, filed on Apr. 6, 2016.

(51) Int. Cl. C21D 9/00; C23C 8/26; F27D 19/00; F27D 7/06; F27D 21/00

(52) U.S. Cl. CPC C21D 9/0056; F27D 7/06; F27D 21/0014; F27D 19/00; C23C 8/26; F27D 2019/0012; F27D 2019/0018

(57) ABSTRACT

A control system for heat treatment of a stainless steel part in a furnace having an internal heat treatment chamber with a treatment atmosphere therein arranged in a plurality of zones, the system including at least one analysis apparatus for each one of the plurality of zones, each analysis apparatus in communication with a respective one of the zones for providing a gas to said zone, analyzing an atmosphere of said zone, and sensing a temperature of said zone for determining commencement of nitriding in the treatment atmosphere. A related furnace is also provided.

### BACKGROUND OF THE INVENTION

The present embodiments relate to apparatus and methods for sensing, analyzing and controlling atmospheres in which stainless steel heat treatment occurs.

Stainless steel heat treatment, including annealing, brazing, sintering, etc., must take into account atmosphere analysis, hydrogen sensing, nitriding sensing, in addition to oxygen and nitrogen-hydrogen mixtures when producing steel components with particular metallurgical and mechanical properties. Systems and methods are known which include same.

For example, it is known that certain stainless steel components with excess alloying content (especially chromium) may pick-up nitrogen (in atomic form) if the steel components are heat treated with nitrogen containing mixtures. Therefore, the known processes and related atmospheres usually contain a high concentration of hydrogen and in fact, it is not unusual to have atmospheres of 100% hydrogen used during the processing of the steel.

### SUMMARY OF THE INVENTION

The present embodiments will control and optimize furnace atmosphere conditions for a stainless steel heat treatment process.

There is therefore provided a control system or apparatus for stainless steel heat treatment in a furnace having an internal heat treatment chamber with a treatment atmosphere therein arranged in a plurality of zones; the control system consisting of at least one analysis apparatus for each one of the plurality of zones, each analysis apparatus in communication with a respective one of the zones for providing a gas to said zone, analyzing an atmosphere of said zone, and sensing a temperature of said zone for determining commencement of nitriding in the treatment atmosphere.

A furnace for stainless steel heat treatment is also provided which includes an internal heat treatment chamber having a treatment atmosphere therein arranged in a plurality of zones; at least one analysis apparatus for each one of the plurality of zones, each analysis apparatus in communication with a respective one of the zones for providing a gas to said zone, analyzing an atmosphere of said zone, and sensing a temperature of said zone for determining commencement of nitriding in the treatment atmosphere.

A related method is also provided herein.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a schematic of a portion of an apparatus for avoiding nitrogen pick-up in a stainless steel heat treatment process; and

FIG. 2 shows a Table representing measurements of certain aspects of a furnace having for example four (4) Zones.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

In general, the present embodiments include a control apparatus and method embodiments, wherein sensing and measuring of nitrogen potential in a stainless steel processing atmosphere is done by using oxygen (O₂) and nitriding sensors/probes for determining when the actual nitriding begins in order to regulate nitrogen/hydrogen ratios in the atmosphere and temperatures in at least one zone of the atmosphere in which the stainless steel is being processed.

The present embodiments provide for an optimum mixture (ratio) to allow full reduction and annealing time required to meet the metallurgical specifications, and allow a minimum time for nitriding in order to eliminate nitrogen (N₂) pick-up.

The present embodiments measure nitrogen potential with various oxygen and nitriding sensors and probes, and determine when the actual nitriding starts. The embodiments of the present invention will regulate the nitrogen and hydrogen ratios in a given atmosphere, and the temperature in at least one location in the high temperature zones of the furnace. The nitriding starts only when the oxide is fully reduced from the surface of the material and therefore, the system will insure the most optimum mixture to allow full reduction (for bright surface) and annealing time required for the metallurgical specifications, and also allow minimum time for the nitriding (to eliminate nitrogen pick-up) as this is a time dependent diffusion phenomenon.

Analysis equipment for oxygen, nitriding potential and temperature sensors will accomplish the foregoing.

The present embodiments avoid nitrogen pick-up, while at the same time maintain an atmosphere mixture of nitrogen and hydrogen.

The probe/sensor apparatus embodiment will, in a single measurement, measure temperature and oxygen, and nitriding potential.

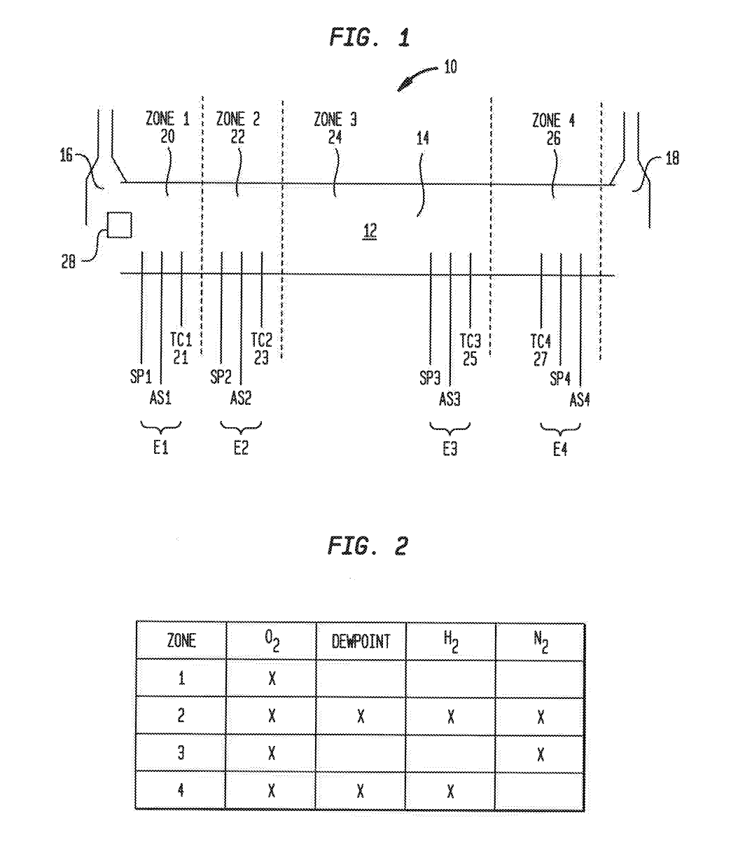

Referring to FIGS. 1-2, a furnace 10 having an internal chamber 12 in which a processing atmosphere 14 is present is divided or segregated into a plurality of zones. The zones may be from at least three (3) to as many as six (6) zones, each one of the zones being equipped with analysis equipment E1-E4 as shown in the FIG. 1. By way of example only, the furnace is segregated into a plurality of zones numbered Z1 to Z4. An entry 16 or inlet, and an exit 20 or outlet of the furnace are in communication with the internal chamber 12 as shown in the FIG. 1.

Each one of the zones is provided with its own separate, discreet analysis assembly E1-E4, and each of the assemblies includes a gas supply “S”, and analysis “A” and temperature “T” measurement equipment, such as a thermocouple or a probe. The temperature measurement in each Zone may be performed by a corresponding thermocouple (TC) dedicated to each Zone.

The plurality of the Zones are identified as Zone 1, the entry zone 20 with a temperature 21; Zone 2, the pre-heat zone 22 with a temperature 23; zone 3, the high-heat zone 24 with a temperature 25; and zone 4, the cooling zone 26 with a temperature 27.

For example, Zone 1 includes an analysis apparatus consisting of a gas supply SP1, an analysis device AS1, and a thermocouple TC1 dedicated to and in communication with that Zone. A sample point (SP) is an atmosphere gas of a particular Zone that is extracted from that Zone for analyzation by gas analyzers or probes. Zones 2-4 have similar analysis apparatus for coacting with their respective Zones, as shown in FIG. 1.

In operation, as a stainless steel part 28 is introduced into the furnace 10 at the entry 16, such steel part will pass through Zones Z1-Z4 and, based upon an alloy composition of the part, a temperature of the atmosphere of each Zone will be determined automatically to identify and create a condition in which a surface of the stainless steel part will be improved for full reduction and annealing.

The atmosphere in each one of the Zones 1-4 will be slightly reduced for alloy oxides to an amount sufficient to prevent oxide reduction at the stainless steel part 28 from occurring before said part has reached the designated high heat zone 24. At the zone 24, nitriding will end or will be of a short enough duration that it will not be affected by the nitriding atmosphere due to the limited time spent by the part 28 in this zone.

Upon reaching the high heat zone 24, a nitrogen-hydrogen (N₂—H₂) mix can be adjusted in that zone so that oxide reduction of the stainless steel part 28 is complete at a temperature where a risk of nitriding no longer exists. The high heat zone 24 is accordingly adjusted to provide H₂ only until the temperature of the stainless steel part 28 is reduced below a point where nitriding of the steel part is no longer at risk.

Each of the Zones 1-4 is equipped with a corresponding nitrogen and hydrogen supply introduced through a corresponding one of the gas supplies SP1-SP4, as shown in FIG. 1, so that the system will provide a correct amount of oxygen partial pressure, and a nitriding potential for the stainless steel part 28 by adjusting a ratio of nitrogen to hydrogen.

Referring to FIG. 2, the table represents an analysis resulting from method embodiments of, for example, a four (4) Zone furnace. The selection of the analysis depends upon temperature profiling of the furnace 10, i.e. temperature profiling depending upon potential oxidation, reduction or nitriding reactions that could occur in a particular one of the Zones.

Example. Referring to Zone 1, only oxygen (O₂) is sensed as being present in that Zone and accordingly measured, as there is no risk of nitriding in the process but rather, there is only a potential risk of air ingress into the Zone 20 at the inlet 16. The presence of air being introduced into the furnace 10 increases the risk that the steel part 28 may be exposed to oxidation. While in Zone 3, the reducing nitriding potentials need to be measured by oxygen analysis and nitriding potential so that the atmosphere having H₂ and N₂ mixtures can be adjusted accordingly in order to achieve reduced and non-nitriding condition in the furnace 10.

Another embodiment includes a control system for the heat treatment of the stainless steel part, wherein a temperature of the atmosphere of each of the plurality of zones is automatically determined to identify and create a condition in which a surface of the stainless steel part will be improved for full reduction and annealing, based upon an alloy composition of the stainless steel part.

Another embodiment includes a control system, wherein the plurality of zones comprise an entry zone, a pre-heat zone, a high-heat zone and a cooling zone.

Another embodiment includes a control system, wherein the high-heat zone comprises a nitrogen-hydrogen (N₂—H₂) mix adjustable in the high-heat zone to complete oxide reduction of the stainless steel part at a temperature where nitriding no longer exists.

Another embodiment includes a control system, wherein the high heat zone is adjustable to provide H₂ only until the temperature of the stainless steel part is reduced enough to prevent nitriding of the stainless steel part.

Another embodiment includes a control system, further comprising nitrogen and hydrogen in the plurality of zones such that the system comprises a correct amount of oxygen partial pressure, and a nitriding potential for the stainless steel part by adjusting a ratio of the nitrogen to the hydrogen.

Another embodiment includes a control system, wherein the entry zone only provides for oxygen (O₂) to be sensed.

Another embodiment includes a furnace, wherein the plurality of zones comprise from at least three zones up to six zones.

The advantage of the present embodiments is that there is reduced hydrogen consumption for processing the stainless steel; elimination of risk of nitrogen pick-up during the processing; and control with historical data is available regarding the annealing, sintering and braising during the stainless steel processing.

It will be understood that the embodiments described herein are merely exemplary, and that a person skilled in the art may make variations and modifications without departing from the spirit and scope of the invention. All such variations and modifications are intended to be included within the scope of the invention defined the appending claims. It should be understood that the embodiments described above are not only in the alternative, but can be combined.

What is claimed is:

1. A control system for heat treatment of a stainless steel part in a furnace having an internal heat treatment chamber with a treatment atmosphere therein arranged in a plurality of zones, comprising:
at least one analysis apparatus for each one of the plurality of zones, each analysis apparatus in communication with a respective one of the zones for providing a gas to said zone, analyzing an atmosphere of said zone, and sensing a temperature of said zone for determining commencement of nitriding in the treatment atmosphere.

2. The control system according to claim 1 for the heat treatment of the stainless steel part, wherein a temperature of the atmosphere of each of the plurality of zones is automatically determined to identify and create a condition in which a surface of the stainless steel part will be improved for full reduction and annealing, based upon an alloy composition of the stainless steel part.

3. The control system according to claim 1, wherein the plurality of zones comprise an entry zone, a pre-heat zone, a high-heat zone and a cooling zone.

4. The control system according to claim 3, wherein the high-heat zone comprises a nitrogen-hydrogen (N₂—H₂) mix adjustable in the high-heat zone to complete oxide reduction of the stainless steel part at a temperature where nitriding no longer exists.

5. The control system according to claim 3, wherein the high heat zone is adjustable to provide H₂ only until the temperature of the stainless steel part is reduced enough to prevent nitriding of the stainless steel part.

6. The control system according to claim 1, further comprising nitrogen and hydrogen in the plurality of zones such that the system comprises a correct amount of oxygen partial pressure, and a nitriding potential for the stainless steel part by adjusting a ratio of the nitrogen to the hydrogen.

7. The control system according to claim 3, wherein the entry zone only provides for oxygen (O₂) to be sensed.

8. A furnace for stainless steel heat treatment, comprising:
an internal heat treatment chamber having a treatment atmosphere therein arranged in a plurality of zones; and
at least one analysis apparatus for each one of the plurality of zones, each analysis apparatus in communication with a respective one of the zones for providing a gas to said zone, analyzing an atmosphere of said zone, and sensing a temperature of said zone for determining commencement of nitriding in the treatment atmosphere.

9. The furnace according to claim 8, wherein said plurality of zones comprise from at least three zones up to six zones.
